(19) United States
(12) Patent Application Publication
(10) Pub. No.: US 2004/0064805 A1
(43) Pub. Date: Apr. 1, 2004

(54) Enterprise scoped software factory

(76) Inventors: Evan S. Sparago, Troy, MI (US); Jeffrey J. Hall, Brighton, MI (US); Mark E. Gragg, Grand Glanc, MI (US)

Correspondence Address: FISH & RICHARDSON P.C., 1425 K STREET, N.W., 11TH FLOOR, WASHINGTON, DC, 20005-3500, US

(21) Appl. No.: 10/255,755

(22) Filed: Sep. 27, 2002

(51) Int. Cl. G06F 9/44

(52) U.S. Cl. 717/120; 717/101

(57) ABSTRACT

Systems and methods for producing a software product are disclosed. In a beginning of developing a software product, a project manager considers a number of stations, where each station specializes in one of a plurality of process steps for converting existing product descriptions and/or code into code segments operable in enabling the software product. Based on the knowledge of the station specialties, the project manager may distribute a number of tasks associated with developing the software product to the various stations. One of the stations is operable to assemble the enabling code segments into the software product. In this way, expertise is continually made available during multiple development processes for multiple software products. Thus, both a cost and a time for completion of the software products can be reduced, while a predictability of each is improved.

### TECHNICAL FIELD

This description relates to software development, and more particularly to efficient, cost-effective software development.

### BACKGROUND

Conventional software development involves a small team or teams of highly-skilled programmers who come together to build a unique program (or a known program having unique characteristics). Such an approach may be inefficient when, for example, the software is built from scratch in each instance.

The terminology “software factory” has been used to describe a software development process in which, for example, families of large-scale software products are built using some type of standardized process and/or interchangeable parts. This type of development process often attempts to categorize portions of the development process, and frequently involves reuse of items or expertise gained in previous projects.

In a conventional software factory, developers attempt to control production variables to achieve a baseline of predictability, and then gradually improve quality and productivity. For example, a conventional software factory designing three related websites for a single customer might attempt to design portions of a first one of the websites such that portions of the underlying code are reusable, and then reuse that code in developing the second and third websites.

However, such limited reuse is often not sufficient to justify the effort of configuring reusable code in the first place. Also, factory teams must still be assembled to create, in this example, the three websites, and there are ramp-up and ramp-down costs associated with assembling such teams. For example, lines of communication and other organizational details must be established in the ramp-up phase, while the ramp-down phase often involves the loss of expertise gained during the production run, as team members are assigned to other tasks.

Moreover, the development of the software product (e.g., web sites) is linear, and dedicated to one product-line at a time. Therefore, development is relatively slow and, particularly in early instances of a product line, difficult to predict in terms of completion time and cost.

Alternatively, the related web sites could be distributed to three different development sites for faster, more parallel production. However, in this case, costs are increased as multiple teams incur many of the same costs, such as training, organizational set-up, and ramp-down (and associated loss of expertise).

### SUMMARY

In one general aspect, a software product may be produced by fracturing features of the software product and representing each feature with a descriptive module describing that feature. The descriptive modules may be assigned to one of a group of stations, with each station specializing in an associated conversion process. Each of the descriptive modules may be converted, at each of the stations and using the associated conversion process, into a process deliverable, where the process deliverable is operable to implement the feature of its associated descriptive module. The process deliverables may then be joined to obtain the software product.

The descriptive module may be a description of requirements of the software product, or may be a fragment of existing code. Fracturing features of the software product may include distributing common documentation procedures to each of the stations.

Features of the software product may be fractured by identifying integration points in each of the descriptive modules, and the process deliverables may be joined by joining the process deliverables at the integration points.

The process deliverable may be a design document, or may be a code segment. The software product may be a web application.

Each of the stations includes a library of reusable components for implementing its associated conversion process.

In another general aspect, a first feature and a second feature of a software product may be described. A first development process and a second development process for enabling the first feature and the second feature, respectively, may be identified. The first feature may be assigned to a first development site specializing in the first development process to thereby obtain a first enabled feature, and the second feature may be assigned to a second development site specializing in the second development process to thereby obtain a second enabled feature. The first enabled feature and the second enabled feature may be joined to obtain the software product.

A first feature and a second feature may be joined by describing a technique for joining the first enabled feature and the second enabled feature. The first feature and the second feature may be assigned by providing business requirements for incorporation into the first enabled feature and the second enabled feature, respectively.

In another general aspect, a system for producing a software product may include a first station that is operable to convert a product description into a design document specifying techniques for producing product code enabling the product description. The system may also include a second station that is operable to produce the product code from the design document. A third station that operable to convert a first code segment into a second code segment, the second code segment designed for integration with the product code may also be included, along with a fourth station that is operable to integrate the product code and the second code segment.

In such a system, the software product may be a website, and the product description may includes a wireframe model of the website. A functionality of each of the first, second, third and fourth stations may be documented prior to production of the software product, and the product description, design document, first code segment and second code segment may be assigned to each station according to the functionality of each station, respectively.

The third station may include a library of reusable software components operable to implement conversion of the first code segment to the second code segment.

In another general aspect, a system for producing a software product may include means for fracturing features of the software product, as well as means for assigning the features of the software product, based on a knowledge of a functionality of each of a plurality of stations. Such a system may also include means for enabling at least one of the features at each of the plurality of stations, to thereby obtain a plurality of enabled features, and means for assembling the enabled features into the software product.

The details of one or more implementations are set forth in the accompanying drawings and the description below. Other features will be apparent from the description and drawings, and from the claims.

### DESCRIPTION OF DRAWINGS

FIG. 1 is a block diagram of a development environment for a software product.

FIG. 2 is a process flow, for the development environment of FIG. 1.

FIG. 3 is an organizational graphic illustrating an enterprise-scoped software factory.

FIG. 4 is a block diagram illustrating one technique for fracturing a software product.

FIG. 5 is an architecture diagram for a web application.

FIG. 6 is a block diagram of a set of design stations.

FIG. 7 is a block diagram of a set of production stations.

FIGS. 8-10 are block diagrams illustrating portions of FIG. 7 in more detail.

FIG. 11 is a block diagram of an organizational structure for implementing an enterprise-scoped software factory.

### DETAILED DESCRIPTION

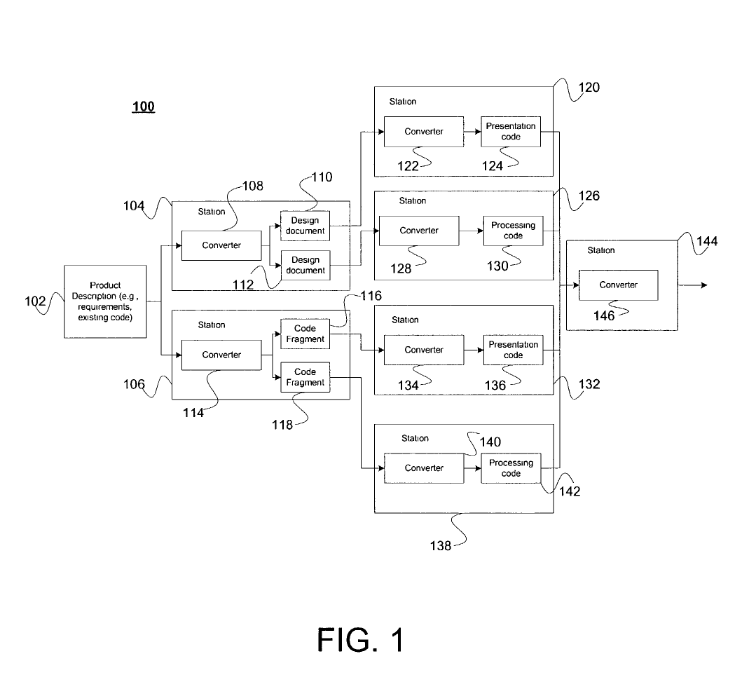

FIG. 1 is a block diagram of a development environment 100 for a software product. As shown, a product description 102 is determined by a project manager. The product description 102 may include, for example, a high-level description of various requirements or features of the product. The product description 102 may also include existing code or code fragments, in the case where an existing product is being upgraded, incorporated into or with another product, or otherwise modified.

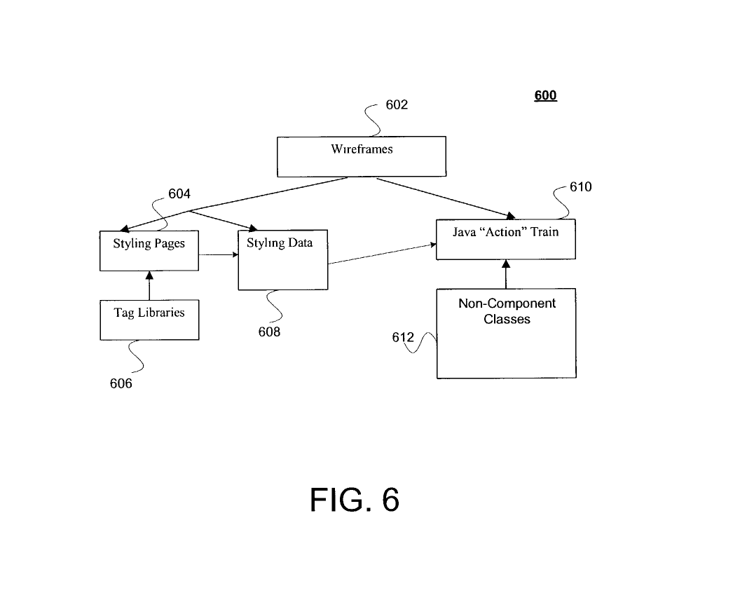

When the software product is to be a web site, the product description 102 may also include, for example, a “wireframe” or mockup of the desired website. A wireframe is (often) a non-functional demonstration of a website, and is often limited to a black-and-white skeleton of the desired end product. The use of a wireframe is discussed in more detail with respect to FIGS. 6-10.

Product description 102 is forwarded to stations 104-and 106. Station 104 includes a converter 108 that uses at least a portion of the product description 102 to produce design documents 110 and 112. It should be understood that there may be various stations with the same or similar functionality as station 104, and that station 104 may have more than one converter 108. Whatever the number and function of stations such as station 104, the project manager may decide how to distribute portions of the product description 102 among them, based on a predetermined functionality of converters such as converter 108 and areas of expertise of operators at station 104. Similar comments apply to station 106, which includes a converter 114 that uses code from product description 102 to produce code fragments 116 and 118.

Thereafter, design document 110 is forwarded to station 120, which uses a converter 122 to transform design document 110 into a segment of presentation code 124. Similarly, design document 112 is forwarded to station 126, which uses a converter 128 to transform design document 112 into a segment of processing code 130.

It should be understood that presentation code 124 and processing code 126 are meant to generically describe types of code that may be output by converters 120 and 126 to fulfill requirements of design documents 110 and 112, and that various other types of code could be output by converters 122 and 128. In one implementation, presentation code is Hyper-text Markup Language (“HTML”) code designed to present content to a user through a web browser. In the same implementation, processing code is Java Server Pages (JSPs) that may be used in processing, for example, a business transaction over the web browser. These examples of presentation and processing code, along with other examples, are discussed in more detail below.

Similarly, a station 132 uses code fragment 116 to produce presentation code 136, and a station 138 uses code fragment 118 to produce processing code 142. In one implementation, code fragments 116 and 118 are HTML, presentation code 136 is modified HTML, and processing code 142 is JSP. Again, these and other specific examples are discussed below.

Finally, a station 144 provides the presentation code segments 124 and 136, along with the processing code 130 and 142, to a converter 146 that produces the finished software product. Station 144 may use the product description 102 to guide the reassembly process.

It should be understood that there exist many variations on the development environment 100 of FIG. 1. For example, any of the various design documents and code fragments may be assigned to multiple stations. Similarly, the various code outputs of stations 120, 126, 132, and 138 need not be assigned to only one station 144 for final assembly; rather, subsets of the code outputs could each be forwarded to other stations (not shown) for partial reassembly. Then, a station such as station 144 could perform final assembly of the code subsets. Also, any one station may have more than one converter, and any two or more stations may be implemented together at a single site, such as a resource center.

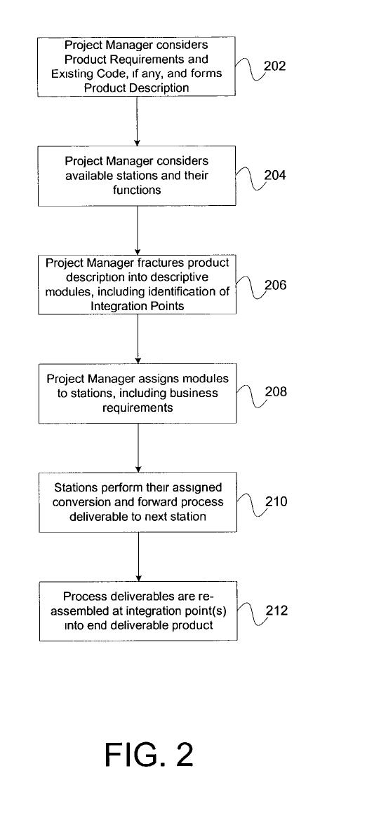

FIG. 2 illustrates a process flow for the development environment 100 of FIG. 1. Initially, the project manager considers product requirements of the end software product, as well as any existing code, and forms the product description 102 (202). Product requirements may include technical requirements, such as a need to access a particular database or tool. Product requirements may also include business rules that are more particular to an enterprise which is commissioning the end software product, such as that a sale may only be made when a number of a certain type of valid credit card is entered.

The project manager then considers the available stations and their functions (204). Each of the stations, as referred to above, has a particular technical expertise in a process development step of a software product. These areas of technical expertise are not tied to the various business requirements, although they may involve an ability to incorporate specific business requirements into a particular setting. The fact that the stations have their respective areas of expertise allows each of the stations to become proficient in that area. Workers at the stations can be assigned on a long-term basis, so that they develop a familiarity and expertise in their area. Moreover, the workers need not have expertise in, or knowledge of, the areas of expertise of other stations as those areas apply to the product at hand. Therefore, the various process steps may proceed largely independently of one another, and in parallel where possible, until such time as mutual testing and assembly into the end product is necessary.

The areas of expertise of the various stations may be emphasized throughout the development environment 100. In this way, various project managers will know which such stations are available, and may divide the product description accordingly.

The various stations may be widely dispersed, and may be located in different countries and/or operated by individuals having knowledge of the local language and customs. The development environment 100 allows the integration of such stations (including the training of the local workers) more easily than conventional development environments, since the stations are fairly autonomous in performing their specific tasks.

Having considered the various stations available, the project manager fractures the product description 102 into various descriptive modules for distribution to at least one of the stations (206). In fracturing the product description 102, the project manager may identify various integration points in the fractured product description 102 which will be used later by station 144 in reassembling the code outputs from the various stations/converters into the end product. It should be understood that, if no station currently exists which is suited to perform a needed task, the project manager may work to create such a station, identify it with a resource center (if necessary), document its capabilities, and make it available to the current (and future) projects.

The project manager assigns the descriptive modules to the stations (208). The descriptive modules may include technical specifications as well as specific business requirements.

Next, the stations each perform their assigned conversion process(es), and forward their respective outputs, or “process deliverables,” to a subsequent station (210). The project management, which may be the project manager and/or a lower-level workflow owner (discussed in more detail below) may be responsible for coordinating the timing and substance of forwarding the various process deliverables from one station to the next.

Finally, the various process deliverables are assembled at the previously-identified integration points into the end deliverable product (212).

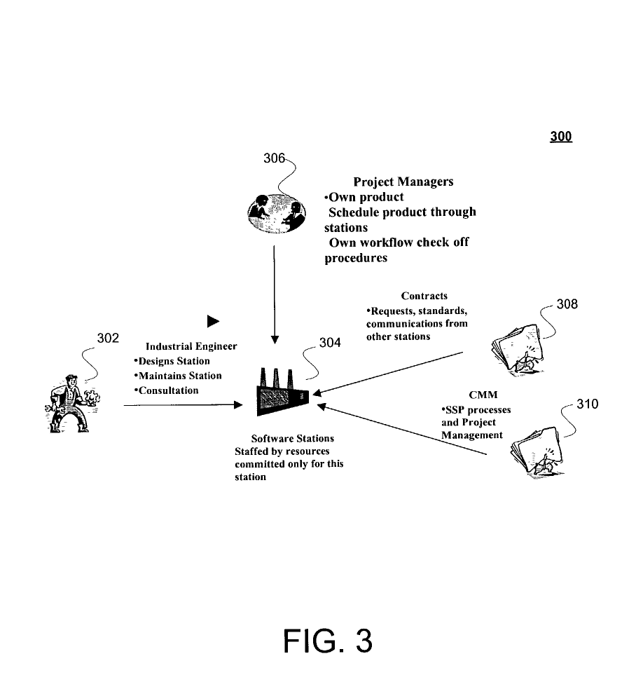

FIG. 3 is an organizational graphic 300 illustrating an enterprise-scoped software factory. In FIG. 3, an industrial engineer 302 is associated with a software station 304. Station 304 contains detailed documentation concerning the development of a software module, as well as information about how the software module, once converted into a process deliverable, should be tested and reattached to at least one other process deliverable.

The industrial engineer 302 is generally responsible for defining the operational processes of the station 304, in a high level of detail and including step-by-step instructions on how to operate the station. These operational processes are available to both local workers and project managers. Industrial engineer 302 is also responsible for ensuring the training of the workers in station 304 for the defined operational processes. Since the industrial engineer 302 generallly is fluent in the local language and customs, such training should be straight-forward and reliable. Moreover, the knowledge that resources are trained removes a major burden from the enterprise resource pool in terms of what projects can be accepted and how long it will take to train resources once the project is accepted.

Industrial engineers from the different stations may communicate and/or form a regularly-meeting industrial engineer council to ensure that outputs from one station match inputs to the next station in the workflow. Such a council may be used, for example, to ensure that staffers in Europe communicate best-in-class toolsets with staffers in Latin America.

Also, industrial engineer 302 is responsible for meeting with the project manager(s) 306 to construct contracts 308 that define the division of labor among stations. The contracts 308 include requests, standards and communications between stations, and represent commitments that business requirements and Applications Programming Interface (“API”) specifications are adhered to by the station(s) 304. The use of these contracts at the station level removes the need to go through project or technical leadership for all, or at least most, communications, and therefore removes a substantial possible bottleneck in communication is flow. The contracts 308 thus ensure that work orders get to the appropriate people in a fast, efficient, and reliable manner.

Project managers 306 oversee the work of the station(s) 304, and are responsible for final delivery and quality of the end deliverable software product. In this regard, it should be understood that the process deliverables output by each station may be independently tested before being forwarded, thereby taking further advantage of the expertise of the station operators. Thus, at a time of re-assembly of the process deliverables into the end deliverable software product, it may only be necessary to perform system-level tests relating to the actual integration process, rather than testing of the process deliverables themselves. In some cases, the station-level testing may obviate the need for further testing of the end deliverable software product entirely.

The project manager 306, along with the industrial engineer 302, is responsible for ensuring that the workers at station 304 are properly trained to operate their respective stations. This use of project manager 306 reduces or eliminates uncertainty in the definition of business requirements and unaccountability in final delivery, since one project manager 306 is responsible for the end deliverable software product. In another implementation, individual “workflow owners” may each oversee some subset of the stations, with each workflow owner reporting to the project manager 306.

Along with contracts 308, the capability maturity model (“CMM”) 310 may be used to ensure that stations are operating and inter-operating as they should. The CMM 310 represents an industry standard for software development, and provides underlying documentation for the station(s) 304, such as a requirement specification form describing the input to the station 304, and a review form proving that the work of the station 304 is reviewed in a pre-defined manner before release). Standard software procedures (“SSP”), another industry standard, may also be utilized for such functions as standardized risk forms detailing the risks of each process.

The implementations described above thus provide for an organizational model that allows project managers to quickly and easily locate and use available, trained workers. By documenting the abilities of the station(s) 304 and providing this documentation throughout the enterprise, the organizational model may persist between projects, and even between product lines. This structure provides for a faster, more cost-effective technique for producing a software product; moreover, the structure allows bids to be constructed faster, easier, and more accurately. These comments apply to third-party vendors as well, assuming that they are willing to commit to, and comply with, the software factory model as described herein.

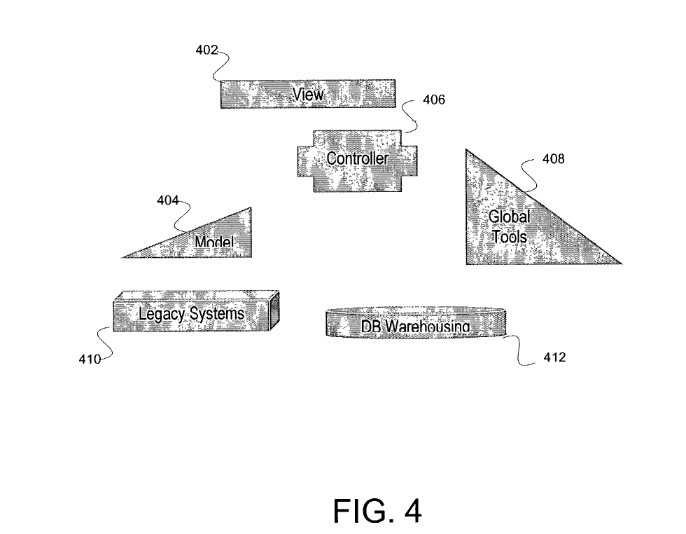

FIGS. 4-9 illustrate more specific examples of the points discussed above. In FIGS. 4-9, it is assumed that the type of software product being delivered is a web site or web application. However, many other types of software products may also be delivered using the same techniques, as would be apparent. For example, any user interface to a customer could similarly be developed, as could virtually any product using object-oriented coding techniques.

The web applications discussed with respect to FIGS. 4-9, for the sake of example, will be a suite of web sites developed for an automotive company. Specifically, the web application includes web sites directed to use by customers of the automotive company, customer service centers, and dealers. Implementations allow these web sites to be developed more quickly and more cost-effectively than if they were developed using conventional techniques. For example, as referred to above, different portions of each web site can be assigned to different stations, where each station specializes in a particular area. As a result, all of the web sites can be in development at the same time, and the fact that the web sites will have many common features between them can be used to speed the development and release of all three.

FIG. 4 is a block diagram illustrating one technique for fracturing a software product. In FIG. 4, a web application is fractured into various descriptive modules. These modules need not have a one-to-one correspondence with software stations, although they may. The modules of FIG. 4 allow for the relation of a user interface to underlying data models, and can be used with a variety of programming languages, such as, for example, Java, Smalltalk, C, and C++.

In FIG. 4, a view module 402 describes elements in a user interface that the user can see and respond to, such as images, buttons, and text-entry boxes. A model 404 may describe a logical structure of data in the web application. Such data may include, for example, a specific “configurator” used by the automotive manufacturer (i.e., a tool for allowing a potential customer to configure a car and select associated purchase options). Model 404 need not contain any specific information about a user interface represented by view 402.

A controller 406 represents the connection between the model 404 and the view 402. The controller 406 dictates what happens when a user takes an action with respect to view 402 such as, for example, clicking on a button or otherwise navigating through a web site.

A global tools module 408 refers to third party applications that are to be integrated into the web application being developed. For example, there may be previously-developed general vehicle configurator or vehicle locator information available to the automotive manufacturer from a previous website, or one that is used as an industry norm. These tools may be integrated into the web application being developed when doing so is faster and cheaper than developing new tools from scratch.

Legacy systems 410 represent systems available to, in this case, the automotive manufacturer from previous website versions, or from general infrastructure.

Finally, a database warehousing module 412 represents data that is available for use by any of the other modules.

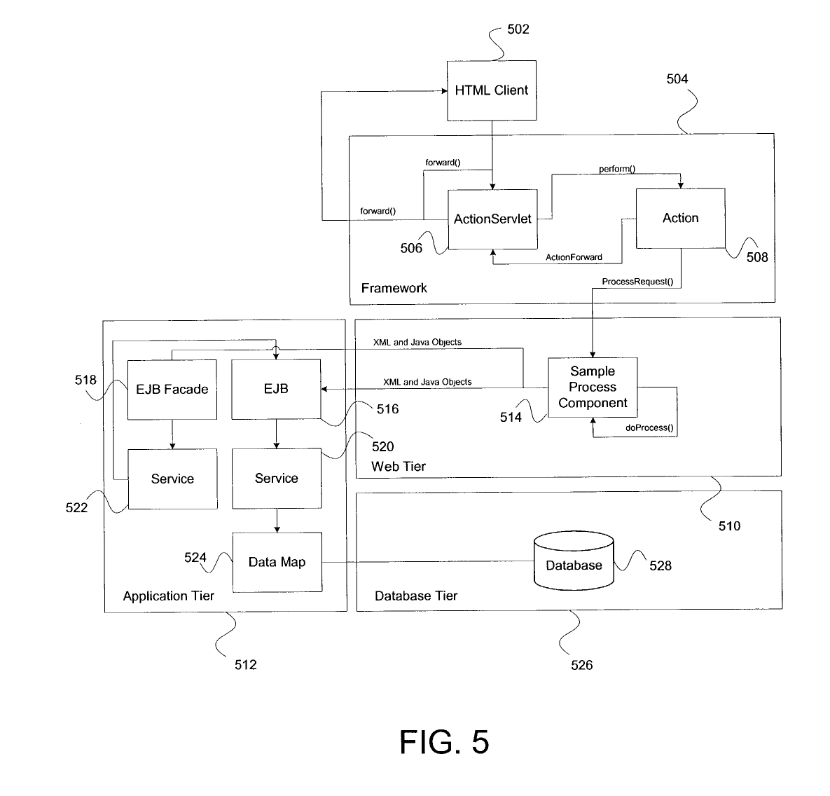

FIG. 5 is an architecture diagram for a web application. In FIG. 5, a HTML client 502 sends a request to a framework 504. More specifically, the request is sent to an action servlet 506 within framework 504. A servlet is generally known as a server-side program useful in generating web pages, particularly “dynamic” web pages that must incorporate some action based on an action of a user.

The action servlet 506 receives the request and maps the request to a methodology of the action servlet. This mapping might be, for example, a conversion from Hyper Text Transfer Protocol (“HTTP”) to Java. An action subsystem 508 receives the request from the action servlet 506 and dispatches the request to a web tier 510. Framework 504, which may be considered to correspond to controller 406 of FIG. 4, may reside in web tier 510.

Web tier 510 may also be referred to as a presentation tier, and may serve to receive the request from action subsystem 508 for dispatch to an application tier 512. More specifically, a sample process component 514 performs this dispatching. The sample process component 514 may be, for example, a JavaBeans component. A JavaBeans component is a pre-defined Java class that complies with agreed-upon coding techniques. JavaBeans components may be used as, for example, components for describing application entities, such as a customer or an order, or may be used in a graphical user interface (“GUI”) as visual items such as buttons or tables. It should be understood that web tier 510 may correspond to view 402 in FIG. 4.

Components such as the sample process component 514 may individually exist for different types of functions, requests, or views, and may relate more to specific “business” items such as a customer, or to “display” items, such as an order form. Such web tier components can be developed independently of the framework 504, and may be obtained in whole or in part from commercial sources. For example, “Struts” is an opensource source of framework components (or generic forms thereof) developed by the Apache Software Foundation, which provides web tier components common to many applications that might be developed.

The application tier 512 corresponds generally to the model module 404, and has application-specific rules, particularly for business logic. Business logic may be encapsulated in discrete forms, such as, for example, Enterprise JavaBeans (“EJBs”). EJBs are similar to JavaBeans in that they both represent component models for web applications. However, whereas JavaBeans are typically used for user-interface and client-side tasks, EJBs are typically used for server-side, component-based development.

EJBs are generally responsible for implementing business rules associated with the application, and may be thought of as “business components” such as invoices and customer accounts. During use within a particular application, the application tier 512 may specify how the EJB should be used, for example, to govern access and updates to an invoice.

In FIG. 5, the sample process component 514 is shown as accessing a particular EJB 516, as well as an EJB facade 518. The EJB facade 518 represents a technique for handling multiple requests to similar EJBs, and thus simplifies the use of EJBs. Service systems 520 and 522 interact with specific EJBs and are mapped by a datamap 524 to a database tier 526, and, more specifically, to a database 528 within database tier 526. The database tier 526 corresponds to legacy systems 410 and/or database warehousing 412 of FIG. 4. Also in this regard, various JavaBeans or EJBs may map to global tools module 408 in FIG. 4.

Once appropriate data has been gathered from database tier 526, it may be processed and routed back through the action servlet 506 for forwarding as, for example, a Java Server Page (“JSP”), to the HTML client 502. JSPs generally allow improved interaction between servlets and static pages built in, for example, HTML, XML, or plain text. More specifically, JSP allows the insertion of scripts into a static page, where the scripts call actions that would typically be performed by servlets. Instead of using such scripts directly, tags can be used within the static pages that perform the same or similar functionality, and that can be purchased commercially or custom-built for storage in a tag library.

As discussed in more detail below, using JSP allows the static portions of pages to be developed separately from dynamic portions (e.g., request processing portions), with different programmers (at different factory stations) working in their respective areas of expertise. Using JSP also allows the business rules in the EJB 516 to be modified without changing the user interface.

FIGS. 6-10 demonstrate an organizational diagram for a software factory operational to build a web application as described above with respect to FIGS. 4 and 5. FIG. 6 is a block diagram 600 showing multiple design stations. In FIG. 6, a wireframe 602 represent a skeletal, generally non-operational outline of a web page to be developed. Wireframe 602 may be, for example, a mock-up of a web page as a customer hopes the web page will look, along with a description of how each element of the page will function. If a web application is being developed for a customer who already has at least some rudimentary web site, then some portions of associated HTML or other code may be associated with wireframe 602.

Wireframe 602 is input into a styling pages station 604. In styling pages station 604, any HTML code (or other code, such as JSP) is decomposed into logical parts of the page. Specifically, styling pages station 604 is designed to take advantage of the fact that the page to be designed and represented by wireframe 602 and related wireframes will have a consistent look therebetween. As such, certain sections of each page are designed to provide consistent functionality, and can be coded as a single module, for later reuse by following stations.

Thus, workers at the styling pages station 604 work to identify different types of layouts, and partition the page(s) to provide the appropriate level of commonality between pages. More specifically, by analyzing the wireframe 602 in conjunction with existing JSP code in tag library 606, common patterns can be found and the code can be broken into logical pieces (e.g., header or navigation bar). For example, patterns include patterns concerning code that must reside in a JSP and can be reused across pages, patterns concerning code that must reside in a JSP and provides request-specific data/processing (e.g., a “content well”), or patterns concerning code that must be managed using specific pre-identified tools. Once identified, the constituent code can be placed in separate files, or fragments, for later production use.

With respect to FIG. 1, styling pages station 604 can be thought of as analogous to station 106 in FIG. 1, with a converter for converting HTML code into code fragments 116 and 118.

A styling data station 608 is also included in FIG. 6. Styling data station 608 is generally responsible for identifying all data requirements for wireframe 602, particularly data display requirements. Such data requirements may already be set forth in whole or in part as part of a previous web page, or may be new to the web application being developed. These data requirements are assembled into a presentation contract, which is then passed onto a Java component design station 610, as discussed in more detail below.

The presentation contract indicates to the Java component design station 610 what data should be assembled and sent to JSP coders, so that the JSP coders (discussed in more detail below) will be able to perform their functions. In Java component design station 610, then, a technical design document and/or a design summary document may be assembled to specify a design for each business or display component (e.g., EJB or JavaBean) that will be used to support the business requirements received from the styling data station 608 in the presentation contract.

Much of the work done at Java component design station 610 may involve the integration of global tools and a migration from previous technologies to more current technologies, such as a migration from pre-EJBs to EJBs. Therefore, such work may be broadly applicable to future web application designs, and is documented and maintained at the Java component design station 610 for reuse in future projects.

As referred to above, the business (or process) and display components generally contain all business logic initiated by the user interface (e.g., HTML client 502) and all the data preparation for calls to the JSPs. However, some design activities may need to be performed for some new or modified non-component classes, including XML code, interfaces, services, datamaps, entities and generic beans or other API-related activities. This work may be performed in a non-component class station 612. As with the Java component design station 610, these non-components may be documented for later reuse, and output as part of a design document or sent to the Java component design station 610 for inclusion in design documents output from that station.

It should be understood that, as with styling pages station 604, each of the stations described above may be analogized to the stations described with respect to FIG. 1. That is, each station converts, for example, product requirements, business logic, code segments, and/or design documents, into, for example, design documents or code fragments. The conversion operations at each station may include standardized or customized actions or codes that are documented from project to project, and which may be stored and accessible to workers at the stations. In this way, workers at the stations gain expertise in performing a particular task, and project managers may assign tasks accordingly.

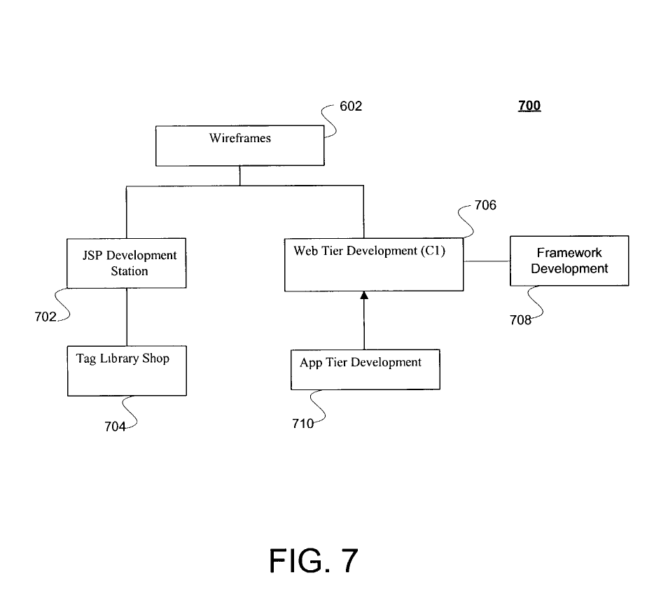

FIG. 7 is a block diagram 700 of a set of production stations. In FIG. 7, wireframes 602 are among the inputs to a JSP development station 702. JSP development station 702 is generally designed to assemble, code, and test the JSPs needed to render the end-deliverable web application as a JSP. A tag library shop 704 is associated with this process and serves to convert the JSP to use tag libraries and for (re-)testing. Tag library shop 704 is useful as part of the Struts framework for allowing java code logic in JSPs to be moved to classes, instead of residing in the JSP itself, in this way, again, reuse is enabled and encouraged.

By isolating the JSP coding step and facilitating local unit testing, these steps can be undertaken at a relatively early stage in the production phase. Thus, developers are allowed to test their code concurrently with the component and framework code development (discussed below), rather than having to wait until those portions of development are complete before testing. This process enables earlier identification of client-side bugs, and speeds integration testing of the end deliverable.

Moreover, isolating the tag library coding from the JSP coding enables stations to function in more of an assembly-line manner, with each station specializing in its own area and not required to have training or an in-depth understanding of the other area's responsibilities. For example, the JSP coders do not need to spend time ramping up on the use of tag libraries, and the tag library coders can focus on implementing efficient, reusable tag library code, without having to spend time on page behavior/appearance requirements.

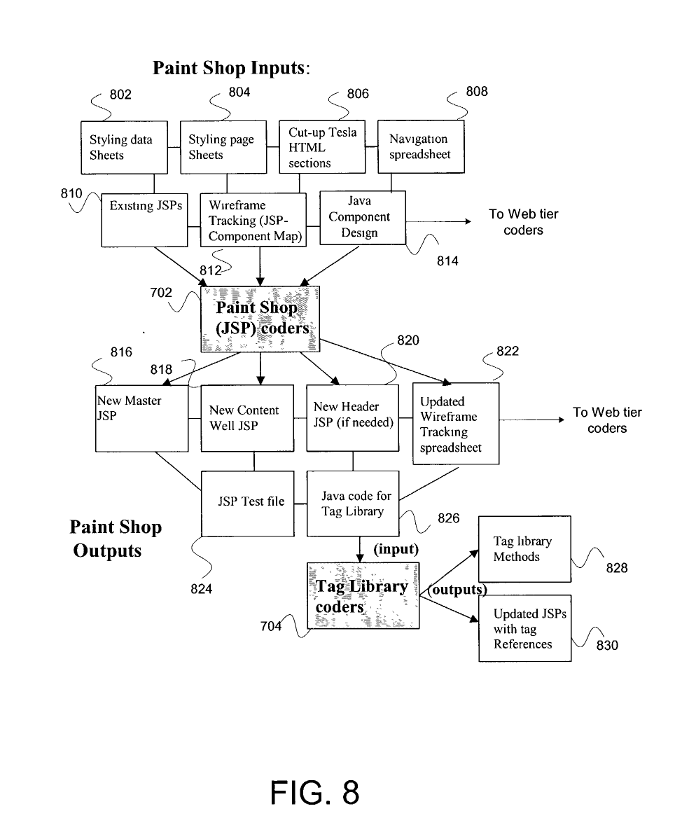

FIG. 8 is a block diagram illustrating portions of FIG. 7 in more detail. Specifically, FIG. 8 illustrates JSP development station 702 and tag library shop 704 in more detail. In FIG. 8, JSP development station 702 inputs styling data sheets 802 from styling data station 608, which provide data requirements and names of existing JSPs 810 to use. Styling page sheets 804 from styling pages station 604 provide layout requirements and names of HTML fragments 806 to be used as a starting point for creating the JSP code. A navigation spreadsheet 808 that may be generated from wireframe 602 has information related to navigation levels needed to use as input parameters for each page to which the JSP code being created will have links. A wireframe-tracking (JSP-Component map) document 812 based on wireframe 602 may also be used, and a Java component design document 814 from Java component design station 610 provides expected presentation values associated with the component(s) that will render the end-deliverable web site.

JSP development station 702 may thus output a new master JSP file 816, a content well JSP file 818, a new header JSP (if needed) 820, an updated wireframe tracking spreadsheet 822, a JSP test file 824, and a Java code file 826 for tag library station 704. Tag library station 704 uses the Java code from file 826 to produce tag library methods 828 and updated JSPs with tag references 830.

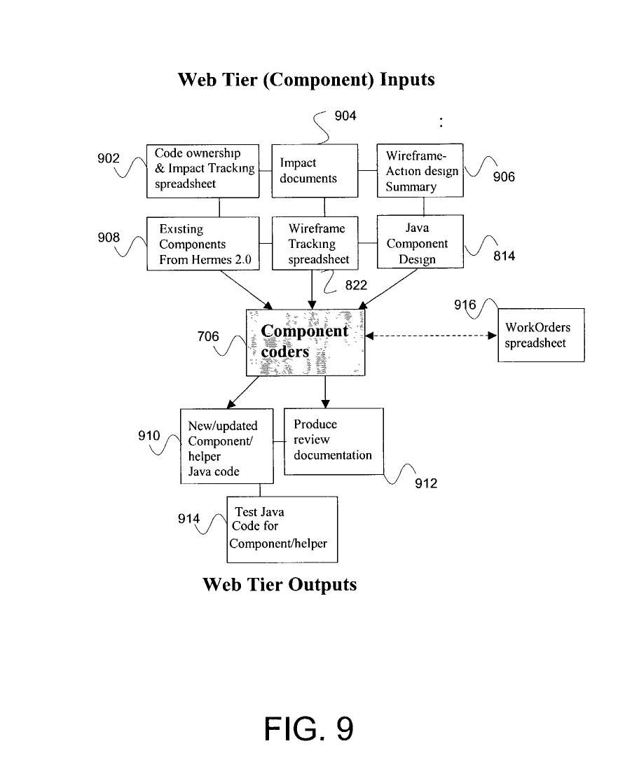

FIG. 9 is a block diagram illustrating portions of FIG. 7 in more detail. Specifically, FIG. 9 illustrates web tier development station 706, which is designed to interact with JSP development station 702, framework development station 708, and application tier development station 710 to perform development activities related to the web or presentation tier 510 of FIG. 5. For example, components and non-component classes may be modified or added to support (i.e., produce, test, and review) needed business requirements to be implemented in the application tier 512 of FIG. 5.

Web tier component development station 706 inputs a code ownership and impact tracking spreadsheet 902, along with impact documents 904, which together document an impact that code changes made elsewhere may have on a particular piece of code. A wireframe-action design summary document 906 and a java component design document 814 are also input into web tier component development station 706. These documents provide component design information from Java component design station 610. Existing components 908, if any, from an existing web site may also be used, and the wireframe tracking spreadsheet 822 may be input from JSP development station 702.

Web tier development station 706 may thus output Java code 910 to enable new or updated components or related non-component code, as well as review documentation 912 such as was discussed with respect to CMM documents 310 in FIG. 3. Test Java code 914 may also be output for testing functionality of the Java code 910. Finally, workorders spreadsheet 916 may be tracked by a project manager to ensure that the components developed in web tier development station 706 are compatible with outputs of application tier development station 710 and a framework development station 708.

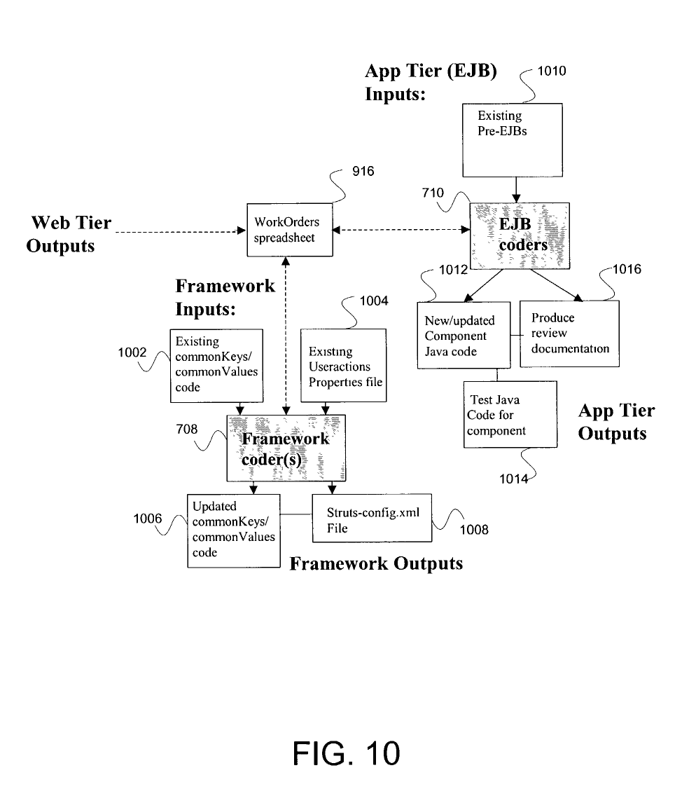

FIG. 10 is a block diagram illustrating portions of FIG. 7 in more detail. Specifically, FIG. 10 illustrates the operations of framework development station 708 and application tier development 710.

In framework development station 708, properties for action servlet 506 and action subsystem 508 are defined. Specifically, action servlet 506 will generally send JSP data to the web tier 510 on a “presentation object” containing a hashtable with “key-value” pairs, where “key” refers to a unique name assigned by a Java developer for a “value” representing certain data related to the key. For example, a JSP field may be assigned a name by the JSP developer, which may then be communicated to all development teams via standard documentation. When a user enters a value into a text field (for example, in a web browser), the field name and value may be associated in, for example, a hashtable as a key-value pair and sent to the JAVA component. If the JAVA component requires the entered text, it may reference the appropriate field name.

Thus, framework development station 708 may input existing key/value pairs 1002, along with an existing useractions properties file 1004 identifying various actions that a user of HTML client 502 may take, and outputs updated key/value pairs 1006. Framework development station 708 also outputs a struts-config.xml file, which, in the Struts framework, controls a dispatch from action servlet 506 to action subsystem 508.

In application tier development station 710, pre-EJB business logic 1010 is input and converted into new/updated Java code 1012 and associated test Java code for each EJB. As with web tier development station 706, application tier development station 710 produces review documentation 1016. Finally, it should be understood from FIG. 10 that framework development station 708 and application tier development station 710 track workorders spreadsheet 916 to ensure that their respective outputs are compatible with the outputs of web tier development station 706.

It should be understood that the various stations discussed with respect to FIGS. 6-10 may be analogized to the various stations illustrated in FIG. 1, with each station performing a step or conversion in a software development process. Because the product was fractured and assigned to existing stations according to the design discussed above with respect to FIGS. 4 and 5, it is then a relatively straightforward process to use a station 144 of FIG. 1 to reassemble the various process deliverables output by the various stations into the end deliverable product demonstrated in FIG. 5.

Moreover, an amount of testing of the end deliverable product should be minimal, since each of the process deliverables received from the various stations should be fully tested and operational. Additionally, in the example above in which a set of three websites are developed for an automotive manufacturer, the stations will perform their respective functions for each of the three websites, using common features of the three to both speed development and design and to provide a common look and feel to the three related sites. This means that the development processes for the three websites may proceed largely in parallel, so that the three websites are developed very quickly.

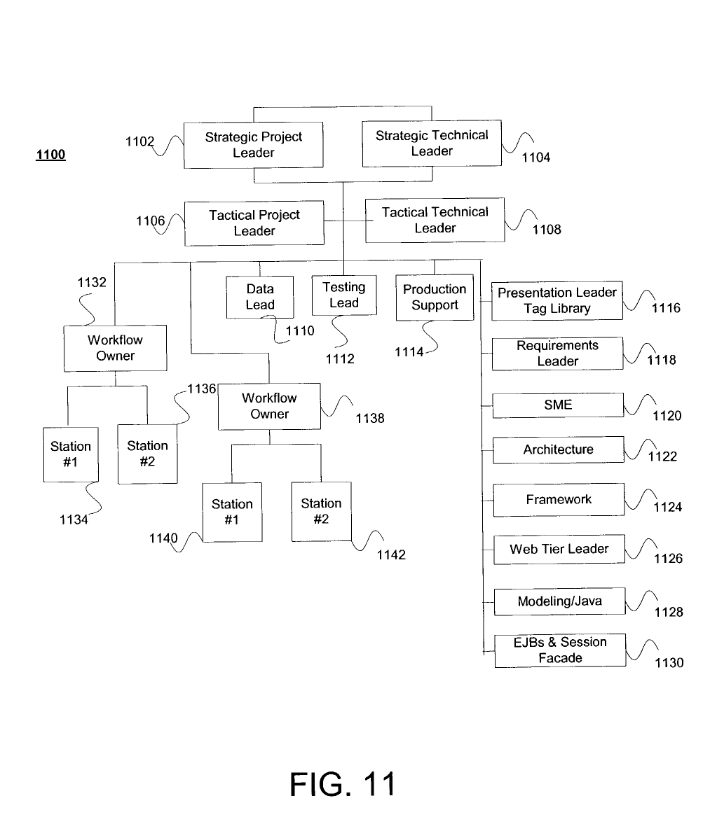

FIG. 11 is a block diagram 1100 of an organizational structure for implementing an enterprise-scoped software factory. In FIG. 11, a strategic project leader 1102 and a strategic technical leader 1104 represent the highest level of leadership for a particular product being delivered. The responsibilities of the strategic project leader 1102 may include, for example, organizing overall program structure, assigning partner deliverables, constructing a strategic project plan, constructing a timeline, monitoring program deliverables, and coordinating communications. The responsibilities of the strategic technical leader 1104 may include, for example, defining an overall technical architecture, certifying partner architectures and designs, identifying integration points and cross partner requirements, and resolving technical issues.

A tactical project leader 1106 and a tactical technical leader 1108 serve to ensure that individual project plan tasks that are the responsibility of the development team are in fact delivered appropriately (this includes all development tasks spelled out in analysis, design, construction, testing and implementation project phases). Each of a plurality of tactical leaders 1106 and 1108, perhaps from different enterprises and/or located in different countries, may be involved in a project at a station-level capacity and overseen by the strategic leaders 1102 and 1104.

Meanwhile, a data lead 1110, a testing lead 1112, and a production support 114 serve to oversee the organization, preparation and execution of program data, test cases and production support issues, respectively. These three elements of the organization structure may be implemented at the strategic or tactical level. In particular, data lead 1110 may be implemented at the strategic level, in order to ensure that data is consistently maintained (for example, avoid data corruption) across all the stations.

In short, organizational members 1102-1114 serve to determine, at a high level, what happens and when it happens with respect to a particular project.

Also in FIG. 11, a presentation leader 1116 for tag libraries serves as an expert on that topic, while requirements leader 1118 serves as an expert on obtaining, outlining, and describing business and other coding requirements. A Corporate Standards Subject Matter Expert (“SME”) may be responsible for verifying that corporate software process guidelines are followed appropriately. An architecture expert 1122 is knowledgeable with respect to an overall architecture of a product, such as described with respect to FIG. 5. A framework expert 1124 and web tier leader 1126 are experts in the functionalities of framework development station 708 and web tier development station 706, respectively.

Similarly, modeling/Java expert 1128 represents an expert in object-oriented programming. For example, such an expert 1128 may be helpful in ensuring that potential enhancements or new program modules are object-modeled (that is, program elements are constructed into individual objects) during a design phase. EJBs and Session Facade expert 1130 may be knowledgeable in tasks related to the operation of application tier development station 710. In short, experts 1116-1130 represent the how of achieving a particular task, and may be thought of as the Industrial Engineers 302 discussed above with respect to FIG. 3.

Finally with respect to FIG. 11, a first workflow owner 1132 oversees a first station 1134 and a second station 1136, while a second workflow owner 1138 oversees another pair of stations including station 1140 and station 1142. As already explained, these portions of the organizational structure 1100 are the parties and sites where the actual conversions take place to produce the process deliverables and, ultimately, the end deliverable software product.

As explained above, implementations of an enterprise-scoped software factory distributes work assignments to be performed at factory stations during, or often even before, an order for an end deliverable software is received. A communication structure for and between the factory stations, along with their respective work assignments, is documented and persistent between projects and product lines, so that a project manager may bid for, and subsequently distribute, a software product development job accordingly.

The factory stations each use their respective areas of expertise to perform some type of conversion process that outputs a process deliverable for forwarding to another station. Factory stations may input one or more process deliverables, and may also output multiple process deliverables. Due to their autonomous and independent natures, the factory stations may be at separate sites, or even in different countries, or may be co-located within one resource center.

Ultimately, the process deliverables are collected at one factory station and integrated into the end-deliverable product for delivery to the customer. Further expertise gained during development of the end-deliverable product is retained at the software station for use during the next project, and is particularly useful when the next project is related to the end-deliverable software product.

A number of implementations have been described. Nevertheless, it will be understood that various modifications may be made. For example, although many of the examples given above have been concerned with the Java programming language, virtually any other object-oriented programming could be used. Accordingly, other implementations are within the scope of the following claims.

What is claimed is:

1. A method for producing a software product, the method comprising:
fracturing features of the software product and representing each feature with a descriptive module describing that feature;
assigning each of the descriptive modules to one of a group of stations, with each station specializing in an associated conversion process;
converting, at each of the stations and using the associated conversion process, each of the descriptive modules into a process deliverable, the process deliverable being operable to implement the feature of its associated descriptive module; and
joining the process deliverables to obtain the software product.

2. The method of claim 1 wherein the descriptive module is a description of requirements of the software product.

3. The method of claim 1 wherein the descriptive module is a fragment of existing code.

4. The method of claim 1 wherein fracturing features of the software product comprises distributing common documentation procedures to each of the stations.

5. The method of claim 1, wherein:
fracturing features of the software product comprises identifying integration points in each of the descriptive modules, and
joining the process deliverables comprises joining the process deliverables at the integration points.

6. The method of claim 1 wherein the process deliverable is a design document.

7. The method of claim 1 wherein the process deliverable is a code segment.

8. The method of claim 1 wherein each of the stations includes a library of reusable components for implementing its associated conversion process.

9. The method of claim 1 wherein the software product is a web application.

10. A method for producing a software product, the method comprising:
describing a first feature and a second feature of the software product;
identifying a first development process and a second development process for enabling the first feature and the second feature, respectively;
assigning the first feature to a first development site specializing in the first development process to thereby obtain a first enabled feature;
assigning the second feature to a second development site specializing in the second development process to thereby obtain a second enabled feature; and
joining the first enabled feature and the second enabled feature to obtain the software product.

11. The method of claim 10 wherein describing a first feature and a second feature comprises describing a technique for joining the first enabled feature and the second enabled feature.

12. The method of claim 10 wherein assigning the first feature and assigning the second feature each comprise providing business requirements for incorporation into the first enabled feature and the second enabled feature, respectively.

13. A system for producing a software product, the system comprising:
a first station operable to convert a product description into a design document specifying techniques for producing product code enabling the product description;
a second station operable to produce the product code from the design document;
a third station operable to convert a first code segment into a second code segment, the second code segment designed for integration with the product code; and
a fourth station operable to integrate the product code and the second code segment.

14. The system of claim 13 wherein the software product is a website, and the product description includes a wireframe model of the website.

15. The system of claim 13 wherein a functionality of each of the first, second, third and fourth station are documented prior to production of the software product, and the product description, design document, first code segment and second code segment are assigned to each station according to the functionality of each station, respectively.

16. The system of claim 13 wherein the third station includes a library of reusable software components operable to implement conversion of the first code segment to the second code segment.

17. A system for producing a software product, the system comprising:
means for fracturing features of the software product;
means for assigning the features of the software product, based on a knowledge of a functionality of each of a plurality of stations;
means for enabling at least one of the features at each of the plurality of stations, to thereby obtain a plurality of enabled features; and
means for assembling the enabled features into the software product.
